(19) United States
(12) Patent Application Publication
(10) Pub. No.: US 2018/0331333 A1
(43) Pub. Date: Nov. 15, 2018

(54) STRUCTURE AND METHOD OF FIXING ELECTRODES OF BATTERY CELL

(71) Applicant: MPLUS CORP, Cheongju-si (KR)

(72) Inventors: Jong Sung KIM, Seongnam-si (KR); Kang Ho KO, Yongin-si (KR)

(21) Appl. No.: 16/032,260

(22) Filed: Jul. 11, 2018

(30) Foreign Application Priority Data
May 11, 2017 (KR) 10-2017-0058482

(51) Int. Cl. H01M 2/10; H01M 10/0587

(52) U.S. Cl. CPC H01M 2/1016; H01M 10/0587

(57) ABSTRACT

Provided are a structure and a method of fixing electrodes of a battery cell. Electrodes in a jelly roll are fixed by a fixing support part (30) (which is formed by spraying a solid material) to prevent cathode and anode electrodes (12) (14) from being deformed or distorted during the transportation and handling of the jelly roll accommodated in an outer frame in a type of a can or pouch. The jelly roll is formed by stacking electrodes in a zigzag pattern. The structure includes the battery cell (10) in which separators (16) are respectively interposed between cathode electrodes (12) and anode electrodes (14), and the fixing support part (30) provided around the battery cell (10).

### BACKGROUND OF THE INVENTION

### Field of the Invention

The present invention relates generally to a structure and a method of fixing electrodes of a battery cell and, more particularly, to a structure and a method of fixing electrodes of a battery cell to prevent deformation of electrodes of the battery cell in use or distortion between the electrodes and separators due to an external shock.

### Description of the Related Art

Generally, secondary batteries are rechargeable batteries which can be made in a small size and large capacity, and may have a configuration in which an electrode roll of which a positive electrode, a separator, and a negative electrode are wound together is accommodated in a can to which the negative electrode is connected, wherein a cap is provided to an upper portion of the can. Insulating plates may be installed on upper and lower surface of the electrode roll to prevent contact with the cap and the can.

In the manufacture of angular secondary batteries (hereinafter referred to as ‘secondary batteries’), electrode plates (positive and negative electrode plates) are stacked in a zigzag pattern to form a jelly roll (hereinafter referred to as a ‘battery roll’), which is then accommodated in an outer frame in the form of a can or a pouch, forming a battery. In this manufacturing process, there may be defect such as deformation, distortion or the like in a positive or negative electrode plate during transporting or handling of the stacked battery roll.

There may be a case where a battery cell in which separators are respectively interposed between positive and negative electrode plates is accommodated in the can or pouch of the secondary battery, instead of the battery roll. Also in this case, the above-mentioned problem may occur.

In the meantime, in use of the secondary battery having the battery cell therein, if the secondary battery is inclined towards one side thereof, cathode and anode materials applied to the cathode and anode electrodes fall towards one side of the battery cell, and separators shrink back so that tips of cathode and anode electrodes protrude beyond the separators. This may cause a short circuit between the cathode and anode electrodes, which may cause serious damage such as explosion of the battery cell.

The foregoing is intended merely to aid in the understanding of the background of the present invention, and is not intended to mean that the present invention falls within the purview of the related art that is already known to those skilled in the art.

### Documents of Related Art

(Patent Document 1) Korean Utility Model Registration No. 20-0228354 (registered on Apr. 12, 2001)

(Patent Document 2) Korean Utility Model Application Publication No. 20-1999-0031053 (Published on Jul. 26, 1999)

(Patent Document 3) Korean Patent No. 10-0478100 (registered on Mar. 11, 2005)

### SUMMARY OF THE INVENTION

Accordingly, the present invention has been made keeping in mind the above problems occurring in the related art, and an object of the present invention is to provide a structure and method of fixing electrodes of a wound-type battery cell to prevent the electrodes from being moved or deformed when the battery cell is accommodated in an outer frame in the form of a can or a pouch. The method is implemented by applying and curing a UV curing agent or a material having a similar function on the battery roll.

Another object of the present invention is to provide a structure and method of fixing electrodes of a battery cell (a general stacked-type battery cell) in which separators are respectively interposed between cathode and anode electrodes, as well as a wound-type battery cell (battery roll), to prevent the electrodes from being moved or deformed when the battery cell is accommodated in an outer frame in the form of a can or a pouch.

In order to achieve the above objects, according to one aspect of the present invention, there is provided a structure for fixing electrodes of a battery cell having separators respectively interposed between cathode and anode electrodes thereof, the structure including a fixing support part provided around the battery cell.

The fixing support part may be a UV coating provided around either an upper or lower side of the battery cell.

According to another aspect of the present invention, there is provided a method of fixing electrodes of a battery cell, the method including the steps of preparing the battery cell having separators respectively interposed between cathode and anode electrodes thereof, and forming a fixing support part around the battery cell to fix the cathode and anode electrodes of the battery cell.

The fixing support part may be formed by applying and curing a UV curing agent.

The fixing support part may be provided around the entire portion of the battery cell having separators respectively stacked between cathode and anode electrodes thereof.

The separator may have an area larger than that of the cathode electrode and the anode electrode so that a tip portion of the separator protrudes beyond the cathode and anode electrodes, and a fixing member may pass through and couple the separators and the coupled fixing member and the separators are fixed by a curing agent such that tip portions of the cathode and anode electrodes are supported by the fixing member.

According to the present invention, the fixing support part is provided to fix the cathode and anode electrodes of the battery cell in order to solve a problem with the related art such as unstable output of a battery due to distortion of the cathode and anode electrodes, or the like, thereby having effects of ensuring stable output of the battery and preventing a failure due to peeling-off of active materials occurring during a motion of the electrodes.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a front view illustrating a structure for fixing electrodes of a battery cell according to an embodiment of the present invention;

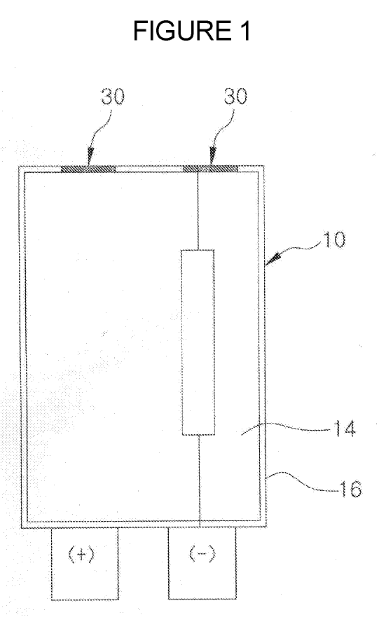

FIG. 2 is a side view of FIG. 1;

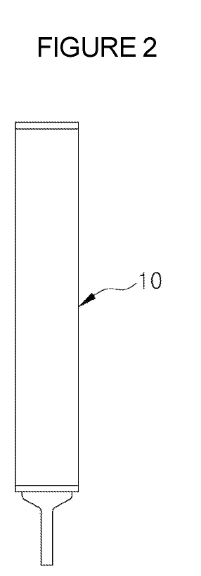

FIG. 3 is a plan view of FIG. 1;

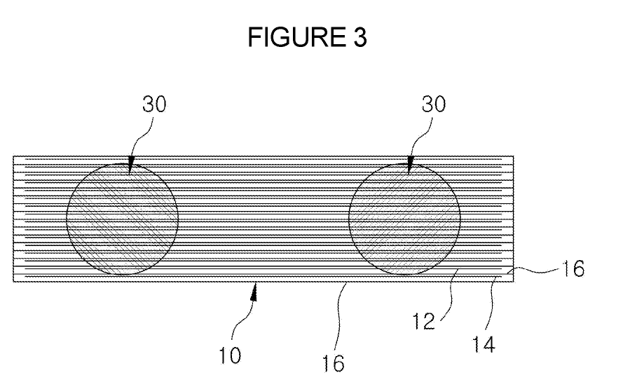

FIG. 4 is a front view illustrating a structure for fixing electrodes of a battery cell according to another embodiment of the present invention;

FIG. 5 is a schematic front view illustrating the structure in which fixing support parts are provided on opposite sides of the battery cell; and

FIG. 6 is a cross-sectional view illustrating a structure for fixing electrodes of a battery cell according to still another embodiment of the present invention.

### DETAILED DESCRIPTION OF THE INVENTION

Hereinbelow, preferred embodiments of the present invention will be described in detail with reference to the accompanying drawings. Objects, features, and advantages of the present invention will be more easily understood when reading the following description with reference to the accompanying drawings. In the following description, it is to be noted that, when the functions of conventional elements and the detailed description of elements related with the present invention may make the gist of the present invention unclear, a detailed description of those elements will be omitted.

It will be understood that although the terms “first”, “second”, “A”, “B”, “(a)”, “(b)”, etc. may be used herein to describe various elements of the present invention, these terms are only used to distinguish one element from another element, and thus do not limit the essence, order or the like of that element. For example, it will be understood that when an element is referred to as being “connected” or “coupled” to another element, it can be directly connected or coupled to the other element or intervening elements may be present therebetween.

Referring to the accompanying drawings, the present invention provides a structure for fixing electrodes of a battery cell 10 having separators 16 respectively interposed between cathode and anode electrodes 12 and 14 thereof, the structure including a fixing support part 30 provided around the battery cell 10. The structure may be referred to as an anti-shaking structure for electrodes in the battery cell.

In an embodiment, the battery cell 10 is fabricated in a roll type by winding. The battery cell 10 is a structure in which separators 16 are respectively interposed between cathode electrodes 12 and anode electrodes 14. For convenience, the cathode electrode 12 and the anode electrode 14 will be hereinafter referred to as electrodes.

The battery cell may include a wound-type battery roll and a stacked-type battery cell in which separators are respectively stacked between the cathode electrodes and the anode electrodes, which battery roll or battery cell may be fixedly accommodated in a pouch or can. That is, it should be understood that the battery cell 10 of the present invention conceptually includes both the wound-type battery roll and the stacked-type battery cell.

Since electrodes of the battery cell 10 are stacked in a zigzag pattern and float in an active material, the electrodes can be easily moved due to external physical force, their own movement, or the like. This may cause reduction in capacitance of a battery, a short circuit of a battery, or the like, having adverse effects on safety of a battery and causing defects thereof. Thus, according to the present invention, electrodes in the battery cell 10 are kept in a constant position by applying a UV curing coating agent onto a lower side of the stacked battery cell 10 and exposing it to light from a curing lamp for a predefined time.

When the battery cell 10 is finished with the separator 16 and fixed with a tape or an adhesive, electrodes may fall towards the grid direction or opposite direction thereof. Thus, although the battery cell is currently surrounded by a tape or the like, electrodes in the battery cell 10 cannot be fixed, and thus are movable.

Thus, according to the present invention, a UV curing coating agent is coated and cured around the electrodes exposed to the outside during the process of forming the battery cell 10 by stacking the electrodes and separators 16. The UV curing coating agent is a fixing support part 30, which is coated around the battery cell 10 and cured by means of a UV lamp, for example. Then, the UV curing coating agent serves as a supporting body to fix the electrodes and separators 16 together to prevent the electrodes in the battery cell 10 from being moved or deformed. The fixing support part 30 may employ other means, instead of the UV curing coating agent, so long so they can fix the electrodes and the separators 16.

In another aspect, the present invention provides a method of fixing electrodes of a battery cell. The method includes the steps of preparing the battery cell 10 having separators 16 respectively interposed between cathode and anode electrodes 12 and 14 thereof, and forming a fixing support part 30 around the battery cell 10 to fix the electrodes (the cathode and anode electrodes 12 and 14) of the battery cell 10. Here, the electrodes and the separators 16 are fixed by the fixing support part 30. As described above, the fixing support part 30 may be formed by applying and curing a curing coating agent in a specified form onto a lower side of a battery cell (jelly roll) 10. The curing agent may be a UV curing coating agent or a liquid material having a similar function so as to apply the battery cell (jelly roll) 10 in a gel type or a spray type. The curing coating agent may be cured with light from a curing lamp. The curing coating agent cured by the curing lamp becomes the fixing support part 30. The applied form of the curing coating agent may have various forms such as “S-type”, “dot-type”, “spray-type”, or the like.

Thus, according to the present invention, stable output of a battery is possible due to no distortion of electrodes in the battery cell 10, and removal of active materials due to shaking of the electrodes is prevented so as to eliminate the occurrence of defects. In the case of a large capacity battery, the deformation of electrodes is problematic. However, according to the present invention, since the movement of the electrodes does not occur, a corresponding failure of a battery can be prevented.

According to the present invention, in use of the secondary battery having the battery cell therein, a phenomenon that, if the secondary battery is inclined towards one side thereof, cathode and anode materials applied to the cathode and anode electrodes 12 and 14 fall towards one side of the battery cell and separators shrink back is prevented by the fixing support part 30 fixing the separators 16. Thus, a phenomenon that tips of cathode and anode electrodes 12 and 14 protrude beyond the separators 16 is prevented, so that a short circuit between the cathode and anode electrodes 12 and 14 is prevented, which may eliminate a serious damage such as explosion of the battery cell.

In the meantime, in another embodiment of the present invention, the battery cell 10 may be a stacked-type battery cell in which separators are stacked between a plurality of rectangular sheets of electrodes. The stacked-type battery cell is fixedly accommodated in a pouch or can. The structure and method of fixing the electrodes of this battery cell 10 in a pouch or can according to this embodiment are the same as that of the former embodiment, so a detailed description thereof will be omitted.

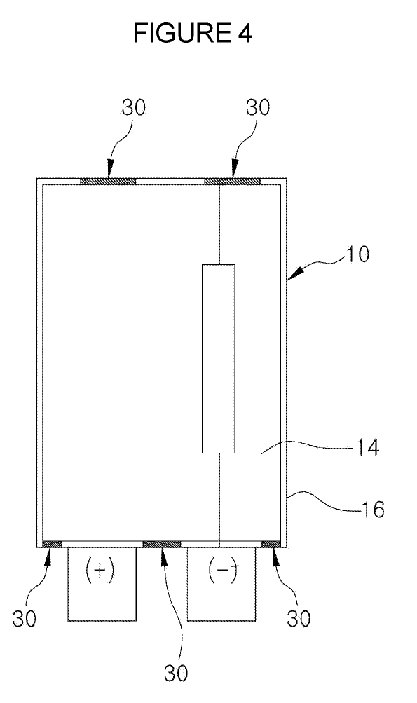

As illustrated in FIG. 4, the fixing support part 30 may be provided on a lower side, as well as on the upper side of the battery cell 10. That is, the fixing support part 30 may also be provided on the lower side of the battery cell 10 from which a battery tap protrudes.

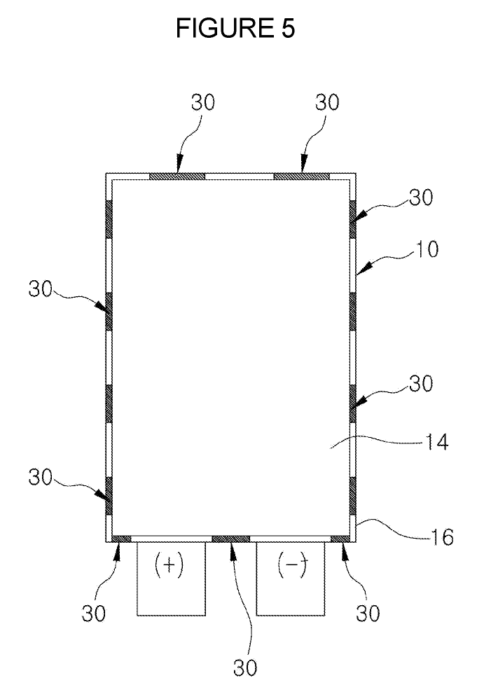

In the case of the stacked-type battery cell in which the separators 16 are respectively stacked between the cathode electrodes 12 and the anode electrodes 14, the fixing support part 30 is formed around the entire battery cell. That is, the fixing support part 30 is formed on opposite sides, as well as on upper and lower sides of the battery cell (See FIG. 5).

Since the fixing support part 30 then fixes the sides of the separators 16, even when in use of the secondary battery, cathode and anode materials applied to the cathode and anode electrodes 12 and 14 fall towards one side of the battery cell or separators shrink back, a phenomenon that tips of cathode and anode electrodes 12 and 14 protrude beyond the separators 16 so that a short circuit is formed between the cathode and anode electrodes 12 and 14 is prevented.

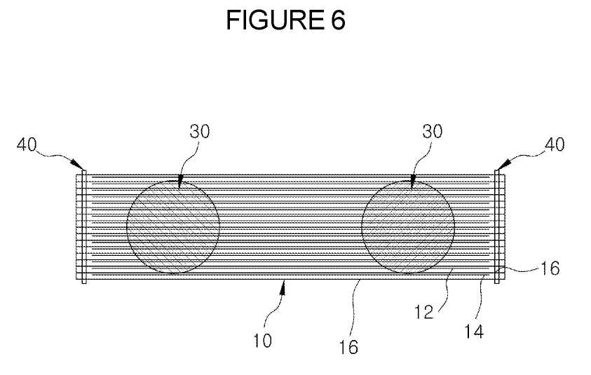

In the meantime, in the case of the stacked-type battery cell, the separator 16 may have an area larger than that of the cathode electrode 12 and the anode electrode 14 so that a tip portion of the separator 16 protrudes beyond the cathode and anode electrodes 12 and 14, and a fixing member 40 may pass through and couple the separators 16 and the coupled fixing member and the separators may be fixed by a curing agent such that tip portions of the cathode and anode electrodes 12 and 14 are supported by the fixing member 40. The fixing member 40 is formed in a pin type, and the respective separators have holes, through which the fixing member 40 is fitted, and the fixing member 40 and the separators 16 are fixed with the curing agent. This structure may be called a stitch-type fixing manner by the fixing member (See FIG. 6).

When the fixing member 40 passes through the separators 16, the fixing member couples and supports the separators 16. Thus, a phenomenon that in use of the secondary battery, the separators shrink back from the circumferences of the cathode and anode electrodes 12 and 14 so that tips of cathode and anode electrodes 12 and 14 protrude beyond the separators 16 is prevented. This also prevents a short circuit between the cathode electrodes 12 and the anode electrodes 14, thereby more securely eliminating damage of a secondary battery occurring due to the short circuit between the cathode and anode electrodes 12 and 14.

Although preferred embodiments of the present invention have been described for illustrative purposes, those skilled in the art will appreciate that various modifications, additions and substitutions are possible, without departing from the scope and spirit of the invention as disclosed in the accompanying claims.

Thus, since the disclosed embodiments are provided to allow those skilled in the art to fully understand the scope of the invention, it should be understood that the embodiment are construed as being not limiting, but illustrative in all aspects, and the present invention is defined by the scopes of claims.

What is claimed is:

1. A structure for fixing electrodes of a battery cell (10) having separators (16) respectively interposed between cathode and anode electrodes (12) (14) thereof, the structure comprising a fixing support part (30) provided around the battery cell (10).

2. The structure according to claim 1, wherein the fixing support part (30) is formed around on at least one of an upper or lower side of the battery cell (10) by curing a curing coating agent.

3. A method of fixing electrodes of a battery cell, the method comprising the steps of:
preparing the battery cell (10) having separators (16) respectively interposed between cathode and anode electrodes (12) (14) thereof; and
forming a fixing support part (30) around the battery cell (10) to fix the cathode and anode electrodes (12) (14) of the battery cell (10).

4. The method according to claim 3, wherein the fixing support part (30) is formed by applying and curing a curing coating agent.
